(19) United States
(12) Patent Application Publication
(10) Pub. No.: US 2011/0087578 A1
(43) Pub. Date: Apr. 14, 2011

(54) SYSTEM AND METHOD FOR CARBON CREDIT TRADING

(75) Inventors: Michael FINCK, Monmouth Junction, NJ (US); Tyler Joseph MAYNARD, New York, NY (US)

(73) Assignee: THE BANK OF NEW YORK MELLON, New York, NY (US)

(21) Appl. No.: 12/576,387

(22) Filed: Oct. 9, 2009

(51) Int. Cl. G06Q 40/00

(52) U.S. Cl. 705/37

(57) ABSTRACT

A computer-implemented system, method, and computer-readable medium for creating and trading securitized environmental offset credits in a registered securities exchange includes providing a processor, memory device, at least one user interface, and a network connection arranged in an online trading platform; registering, in a database in the memory device and via the network connection, one or more environmental offset credits to respective owners thereof; requesting, via the network, equitization of at least a portion of the one or more environmental offset credits by a securities regulator; applying a unique identifier supplied by the securities regulator to the equitized one or more environmental offset credits; and assigning custody of each of the equitized one or more environmental offset credits to a custodian and storing the custodian assignment in the database.

### BACKGROUND

This application is directed to a computer-implemented trading platform, system, and method useful in the creation and trading of novel carbon credit depositary receipts (CCDR) related to, for example, trading in so-called “carbon offset” emissions offsets. Emissions trading or “cap-and-trade” is an administrative approach used to control pollution by providing economic incentives for achieving reductions in the emissions of pollutants.

Carbon credits came into existence as a result of increasing awareness of the need to control emissions. The success of the U.S. Acid Rain Program is noted for proving that a tradable permit system is an effective environmental policy instrument for the industrial sector, provided there are reasonable levels of predictability over the initial allocation mechanism and long-term pricing.

The emission of Greenhouse gases (GHG) by human activity is believed to contribute to global warming and climate change. GHGs are typically measured by an internationally accepted measure, “carbon dioxide equivalent” (CO₂e or CDE), that expresses the amount of global warming potential of a particular GHG in terms of the amount of carbon dioxide (CO₂) that would have the same global warming effect. Examples of GHG's include carbon dioxide, methane, perfluorocarbons, nitrous oxide, sulfur hexafluoride, and water vapor. Carbon dioxide equivalents of these gases are commonly expressed by the United Nations' Intergovernmental Panel on Climate Change Panel (IPCC) as “billion metric tons of carbon dioxide equivalents (GtCO2eq),” in industry as “million metric tons of carbon dioxide equivalents” (MMTCDE), and in vehicles as “grams of carbon dioxide equivalents per kilometer” (gCDE/km).

The United Nations Framework Convention on Climate Change (UNFCCC) is an international environmental treaty produced at the United Nations Conference on Environment and Development in 1992. The treaty is aimed at reducing emissions of greenhouse gases in order to combat global warming. The treaty includes provisions for updates called “protocols”, the most famous of which is known as the “Kyoto Protocol”, an international agreement between more than 170 countries, in which specific limits and reduction requirements have been established for the emission of carbon dioxide and five other greenhouse gases—methane, nitrous oxide, sulfur hexafluoride, HFCs, and PFCs—in countries that have ratified the Kyoto Protocol.

The Kyoto Protocol is a “cap-and-trade” system that defines legally binding national caps and timetables for reducing GHG emissions produced by industrialized countries that are subject to the Kyoto Protocol. Further, the Kyoto Accord formalized the carbon credit mechanism. The Accord agreed on a “cap and trade” system, which provided quotas on the maximum amount of greenhouse gases for developed and developing countries, listed in the Annex to the Protocol. In turn, signatory countries set quotas on the emissions of local businesses and other operators. These businesses and operators can trade in the international carbon credit market to cover their shortfall in allowances. Operators with surplus credits can sell them to operators surpassing their “capped” quotas. The allowances can be sold privately or in the international market at the prevailing market price.

While tree planting was initially used for carbon offsetting, renewable energy, energy conservation, and methane capture offsets have now become increasingly popular. Although emissions reduction and regulation were originally regarded primarily as engineering problems, the problems are now being viewed also as a financial opportunity by the creation and trading, i.e., buying and selling, of emission offset credits. There are active trading programs in several pollutants. For GHG's, the largest is the European Union Emission Trading Scheme (ETS). In the United States, and as mentioned above, there is a national market to reduce acid rain, and several regional markets to reduce nitrous oxide.

The Kyoto accord includes “flexible mechanisms” which allow developed countries listed in Annex I of the Protocol to meet their emission caps by purchasing GHG emission reductions from elsewhere. These can be bought from exchanges, projects which reduce emissions in non-Annex I economies under the Clean Development Mechanism (CDM), other Annex I countries with excess allowances, or in the over-the-counter (OTC). Only CDM-accredited certified emission reductions can be bought and sold in this manner.

Each country that participates in the mandatory Kyoto emission reduction framework and international emissions trading scheme maintains their emission allowances or “carbon credits” on the behalf of companies and the government in an electronic account known as a national registry. Under the Kyoto Protocol, the national registries may be linked with the central registry of the UNFCCC, the International Transaction Log (ITL). Various countries are also joined by the registry of the CDM, which holds carbon credits generated by CDM projects on behalf of project sponsors. In the case of the voluntary markets, voluntary registries may also be used. In either case, as a credit is “retired,” the registries are updated accordingly. Computer interfaces are currently being developed to various national registries to supplement and/or replace the current paper and facsimile system.

The United States Senate did not ratify Kyoto, and the U.S. government does not currently regulate carbon dioxide (CO₂) or other Kyoto GHGs as climate change-related pollutants. To compensate for the lack of national CO₂ regulation, several states have initiated their own regulatory processes, alone or in conjunction with others. For example, in 1997, Oregon enacted the Oregon Standard, the first regulation of CO₂ in the United States. The Oregon Standard requires that new power plants built in Oregon reduce their CO₂ emissions to a level 17% below those of the most efficient combined cycle plant, either through direct reduction or offsets. Plants may propose specific offset projects or pay mitigation funds to The Climate Trust, a non-profit entity created by law to implement projects that avoid, sequester, or displace CO₂ emissions. The European carbon market was approximately $118 billion last year; if the U.S. enters the regulated market, the world-wide market could potentially surpass $2.1 trillion by 2020, which would make it a rival for one of the world's largest commodity markets.

As mentioned, the U.S. has remained outside the regulated market arena by not signing the Kyoto Accord, but U.S. public and political sentiment may be changing, along with the development of international markets for environmental offsets. A proposal to curb US greenhouse-gas emissions recently cleared a key congressional panel, bolstering prospects that the government will put a price on carbon by adopting a “cap and trade” scheme. Climate exchanges have been established that provide a spot, futures and options market on the tradable credits (e.g., Chicago Climate Exchange, European Climate Exchange, Nord Pool, BlueNext, European Energy Exchange, CantorCO2e and Preserval Marketplace). However, the fragmentation of all these exchanges have produced an inefficient market because of segmented liquidity, differing standards, settlements and trading practices. Further, company involvement is currently voluntary.

Outside of Kyoto's mandatory emissions reduction and the above-described governmental efforts at the U.S. state and regional levels, several voluntary market mechanisms have developed, and are rapidly evolving. Using different verification approaches, these voluntary systems have evolved to allow companies or entities in countries not listed in Annex I of the Kyoto Protocol (e.g., Australia and the United States, primarily) to participate in emission reductions in anticipation of future “green” mandates, to fulfill corporate social responsibility, or to improve their image in the public eye, as well as allowing entities already subject to mandatory emission reduction schemes, e.g., EU ETS, to further reduce their GHG emissions beyond Kyoto Protocol requirements. The first voluntary efforts were implemented by Land Use, Land Use Change and Forestry (LULUCF) methodologies, which generally were focused on the planting of trees to provide carbon offsets.

As a general class, voluntary carbon markets include all carbon offset trades that are not required by regulation. Voluntary market transactions include: the purchase of carbon credits by individuals or institutions to offset their emissions; the purchase of credits directly from project developers for retirement or resale; and the donation to GHG reduction projects by corporations in exchange for credits. At the broadest level, the voluntary carbon markets can be divided into two main segments: the voluntary, but legally binding, cap-and-trade system that is the Chicago Climate Exchange (CCX); and the broader, non-binding, over the counter (OTC) offset market.

The voluntary market in North America currently resides mostly in the legally non-binding over-the-counter (OTC) market, while a smaller portion is traded under the voluntary but legally-binding cap-and-trade Chicago Climate Exchange (CCX) mechanism. The voluntary OTC offset market grew by over 200% between 2005 and 2006. Although less than the EU ETS trading volume, the voluntary markets are significant in that they represent an active and growing demand by businesses and individuals for carbon offset trading.

From an economic or market perspective, there is a distinction between a mandatory market and a voluntary market. Typically both markets deal with emission certificates of some form, but in the mandatory market, strict rules have been applied for a project approval and accounting, i.e., “verification.” The voluntary market provides market participants with different options to acquire emissions reductions, and include solutions comparable to those developed for the mandatory market, for example, Verified Emission Reductions (VER). However, there are multiple “standards” in play, with differing scope.

The Chicago Climate Exchange (CCX) defines itself as “the world's first and North America's only voluntary, legally-binding, rules-based greenhouse gas emission reduction and trading system.” CCX is driven by a membership-based cap and trade system. Members voluntarily join CCX and sign up to its legally-binding reductions policy. Like the Kyoto markets, CCX trades 6 different types of GHGs converted into a common unit of tCO2e (i.e., tons of CO₂-equivalent). The CCX's unit of trade is the Carbon Financial Instrument (CFI), which represents 100 tCO2e. CCX CFIs can be either allowance-based credits, issued by emitting members in accordance with their emission baseline and the exchange's reduction goals, or offset credits generated from qualifying emission reduction projects. In 2006, about 10.3 MtCO2e were transacted on CCX. As of July 2007, a total of 26.3 MtCO2e had been traded on the exchange.

As can be seen from the above, the carbon offset market is complex, with many interrelationships between mandatory emission reduction schemes, and voluntary efforts used to either supplant mandatory requirements or to pursue emission reductions in lieu of mandatory requirements in, for example, the United States. Capturing offset data and accounting for the variety of mandatory and voluntary emission offsets and their various standards for all market participants can be difficult, but is necessary to ensure liquidity and transparency in offset trading.

There is a widely-held belief that, to be meaningful, any sustainable emission reduction effort must be implemented by a market driven approach that provides economic incentives for compliance. This is true for both government imposed, and voluntary markets, and is particularly true for the generally unregulated voluntary offset market in which market transparency is necessary for market participants to have faith in offset pricing mechanisms and the underlying quality of the offset. However, market transparency, liquidity, and the resulting ease (or lack of ease) of trade are problems for both mandatory and voluntary carbon offset credit trading. Widespread acceptance and use of such environmental offset schemes will not occur until these problems are either eliminated or significantly reduced.

The carbon credit market exceeded $118 billion in 2008 and, as mentioned above, some industry experts predict that “carbon” could be the world's biggest commodity market, and even the world's biggest overall market. Given the potential for carbon offsets to become a forced market by what appears to be the inevitable risk of government regulation, market drivers include central government's involvement in the regulated “cap and trade” carbon market.

Currently, the carbon market infrastructure is fragmented, but evolving daily with regulation, entry of new participants, and oversight. Currently there are seven exchanges that actively trade allowances; Chicago Climate Exchange, European Climate Exchange, Nord Pool, BlueNext, European Energy Exchange, CantorCO2e and Preserval Marketplace. Potential government regulating agencies include the Securities Exchange Commission (SEC), the U.S. Environmental Protection Agency (EPA), and the Federal Energy Regulatory Commission (FERC).

Conventional approaches to date, e.g., The Bank of New York Mellon's (“BNY Mellon”) Corporate Trust division's Global Environmental Markets registry (GEM) registry, have been developed to assist holders of carbon products in managing the different credit types and standards through a single program with a web interface. Typically, credits are managed separately through various systems and spreadsheets making reporting and tracking an onerous task.

A depositary receipt (DR) is a type of negotiable (i.e., transferable) financial security that is traded on a stock exchange and which, heretofore, represented a security that is issued by a foreign publicly listed company, usually in the form of equity. The DR allows investors to hold shares in equity of companies worldwide in a familiar, convenient, and cost-effective format. One of the most common types of DRs is the American depositary receipt (ADR), which has been offering companies, investors and traders global investment opportunities since the 1920s. Since then, DRs representing an underlying security have spread to other parts of the globe in the form of global depositary receipts (GDRs) (the other most common type of DR), European DRs and international DRs. ADRs are typically traded on a U.S. national stock exchange, such as the New York Stock Exchange (NYSE) or the National Association of Securities Dealers (NASDAQ), while GDRs are commonly listed on European stock exchanges such as the London Stock Exchange. Both ADRs and GDRs are usually denominated in U.S. dollars, but can also be denominated in euros or other currencies. A DR program may be established to facilitate trading in a company's equities in a market participant's home market. For example, when a foreign company wishes to list its already publicly traded shares or debt securities on a foreign stock exchange, it will first have to meet certain requirements put forth by the exchange. In addition, initial public offerings and other capital raisings can be accomplished utilizing DRs which can be traded on a major exchange or over-the-counter.

The DR functions as a means to facilitate global trading, which in turn can help increase not only volumes on local and foreign markets but also the exchange of information, technology, regulatory procedures as well as allowing greater market transparency. Thus, instead of being faced with impediments to foreign investment, as is often the case in many emerging markets, the DR investor and company can both benefit from investment abroad by the trading of equity in a company in a regulated and transparent manner.

What is needed is a system and method useful for improving the transparency and tradability of environmental offset market credits in public markets, e.g., carbon offset credits.

### SUMMARY

Among other things, this disclosure provides embodiments of a trading platform, system, and method for trading and accounting for environmental offsets, for example, mandatory and/or voluntary carbon emission offsets trading. The present disclosure also provides embodiments of a trading platform, system, and method which creates and facilitates the trading of carbon credit depositary receipts, and which consolidates a variety of market and pricing data. The present disclosure also provides embodiments directed to a computer-implemented trading platform, method, and computer-readable medium that facilitates the trading and eventually the retirement of carbon offsets between buyers and sellers.

In one or more embodiments using the trading platform, system and method of this disclosure, a Carbon Credit Depositary Receipt (CCDR) that equitizes or securitizes the underlying credits is traded and settled on an exchange by the assignment of unique identifiers and clearing procedures. For example, the unique identifier may be a Committee on Uniform Security Identification Procedures number (i.e., “CUSIP”), and Depository Trust & Clearing Corporation (DTCC or “DTC”) eligibility may be provided. The equitization of carbon credits in the form of CCDRs would create increased visibility and transparency, and would help remove uncertainties, including validity of the underlying allowance, from the trading and settlement of carbon credits.

In another aspect of this disclosure, centralizing trading with one exchange would greatly increase the liquidity in the market which is currently fragmented by small regional exchanges with shallow liquidity. In other aspects, other greenhouse gases (CO2e) can also be traded, and may be quoted as standard multiples of CO2. In another embodiment, a DR ratio could effectively be set to allow all greenhouse gases to be traded as one security or a basket of securities. Another benefit of setting a DR ratio would be to effectively price the security in a trading amount acceptable to all investors, especially for retail investment.

In one embodiment, a computer-implemented method of creating and trading securitized environmental offset credits in a registered securities exchange includes providing a processor, memory device, at least one user interface and a network connection arranged in an online trading platform. An environmental offset credit received via the network connection may be registered in a database in the memory device to an owner. Equitization of at least a portion of the one or more environmental offset credits may be requested from a securities regulator via the network. A unique identifier supplied by the securities regulator may be applied to the equitized environmental offset credit. Custody of the equitized environmental offset credit may be assigned to a custodian and the custodial assignment may be stored in the database.

The environmental offset credits may be a carbon offset credit established by a voluntary carbon offset market, or they may be a mandatory carbon offset credit required by a governmental entity. Alternatively, the environmental offset credits may be established as a carbon-equivalent offset credit related to other types of greenhouse gases or acid rain, for example.

Once equitized, the environmental offset credits may be traded on a regulated stock exchange and, after trading, the offset credits underlying the equitized environmental offset credits may be retired, for example, retired in an associated national registry. For such equitized securities, the unique identifier can be either a CUSIP or an ISIN identification number.

In one aspect of an embodiment, environmental offset credits may be equitized or securitized by creating a depositary receipt (DR) registered with a governmental regulatory agency, e.g., the Securities Exchange Commission (SEC). Further, the DR may be established as a carbon credit DR (CCDR).

Potential customers of CCDRs include any business or operator in a regulated market, aggregators of credits (e.g., Investment Banks), investors, broker-dealers, banks, custodian's funds, and Exchange Traded Funds (ETF) Sponsors.

In another embodiment, a networked system for computerized creation and trading of securitized environmental offset credits tradable in a registered securities exchange includes an online trading platform comprising a processor, a memory device, at least one user interface, and a network connection operatively coupled together. A structured database may be arranged in the memory device and configured to store registration information received over the network connection and processed by the processor. The registration information may be related to one or more environmental offset credits registered to respective owners.

In one or more embodiments, the processor may be configured, responsive to a user input received over the user interface, to request equitization of at least a portion of environmental offset credits with a securities regulator via the network. Further, the processor may receive, over the network from the securities regulator, one or more unique identifiers associated with the equitized one or more environmental offset credits, and may store the unique identifiers in the structured database. An associated custodian for each of the equitized environmental offset credits may be designated, and the designation of associated custodians stored in the structured database for each of the equitized environmental offset credits.

As in other embodiments, the environmental offset credits may be a GHG mechanism of either the voluntary or mandatory type that may be required by a governmental entity. Further, the environmental offset credits may be a carbon-equivalent offset credit representing greenhouse gases, for example.

In one or more embodiments, the equitized or securitized environmental offset credits may be traded on a regulated stock exchange via an electronic trading system over a network, for example the Internet or a private communications network.

After the equitized environmental offset credits have been traded on the regulated stock exchange, some or all of the offset credits underlying the equitized environmental offset credits may be retired or otherwise made ineligible for further trading. For example, the offset credits may be retired from an associated national registry.

In one or more aspects of this disclosure, at least a portion of the environmental offset credits may be equitized or securitized by creating a depositary receipt (DR) registered with a governmental regulatory agency, for example, the Securities Exchange Commission (SEC). The DR may be established as a carbon credit DR (CCDR). The unique identifier applied or established by the securities regulator may either be a CUSIP or an ISIN identification number.

In another embodiment, an article of manufacture includes a tangible computer-readable medium that contains computer-readable instructions thereon. When these instructions are executed by a computer processor, the processor may be caused to carry out functions related to creating and trading securitized environmental offset credits in a registered securities exchange. For example, the functions may include registering, in a structured database in a memory device, one or more environmental offset credits to respective owners thereof; requesting equitization of at least a portion of the one or more environmental offset credits by a securities regulator; storing, for each equitized one or more environmental offset credits, a unique identifier supplied by the securities regulator in the structured database; and assigning, to a custodian, custody of the equitized one or more environmental offset credits in the database.

Further, CCDRs with identical characteristics may be pooled together, further enhancing liquidity. CCDRs with different characteristics could be used to construct Carbon Credit Exchange Traded Funds (ETF) which would deepen liquidity and ease diversification of portfolio risk. The issuance/cancellation of CCDRs provides an excellent way to monitor and ensure proper retirement of credits.

### BRIEF DISCUSSION OF THE DRAWINGS

FIG. 1 provides a block diagram of an embodiment of a computer-implemented trading platform of this disclosure and its surrounding environment.

FIG. 2 illustrates a high-level conceptual process flow of an embodiment of a trading platform directed to the creation and retirement of CCDRs.

FIG. 3 illustrates a functional block diagram of an embodiment of the trading platform of FIG. 1.

### DETAILED DESCRIPTION

In the discussion of various embodiments and aspects of the trade platform and method of this disclosure, the “starting point” is not required to be at the project level, i.e., at a level that is creating a new offset credit. Instead, the method and trade platform of this disclosure may alternatively start processing at a point where the owner of an existing offset credit desires to trade the already established and verified offset credit. Further, while various embodiments below indicate the use of a broker/dealer (“B/D”), it may be possible, subject to legal constraints, for an investor to register an offset with the trading platform manager (“P/M”) directly, and avoid the use of a B/D, if desired.

Transparency applies not only to the valuation of voluntary and mandatory offsets, but to the related aspects of the underlying standards to which an offset was initially verified to ensure, inter alia, that an offset represents a “real” project which offers “additionality”, for example, and also ensures that no double counting is allowed occurs when an offset is created or “retired.” Providing such transparency works to ensure a liquid market where buyers and sellers can freely engage with reduced investment risk. Although trading of “verified” offsets, i.e., offsets established in accordance with publicly recognized standards may be preferable from the standpoint of reducing investment risk, the system and method of this disclosure may be used to trade emission credits that are either verified to some currently-recognized standard, or those that are not.

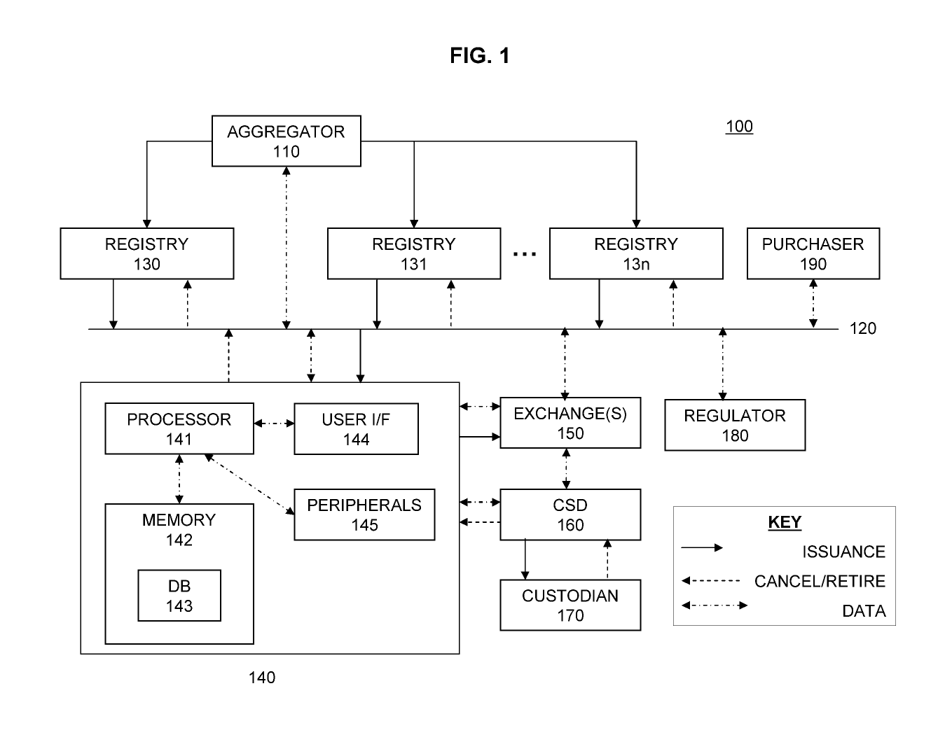

In FIG. 1, trading system 100 encompasses the various actors that may be involved with the creation, trading, and retirement of equitized environmental offset credits of various embodiments of this disclosure. Aggregator 110, e.g., an investment bank (IB) or broker/dealer (B/D), negotiates with companies that possess environmental credits, e.g., carbon credits, and that may or may not be registered with one or more national registries 130, 131, . . . 13n (i.e., mandatory offsets versus voluntary offsets). Aggregator 110 represent entities that either facilitate identification of emission offsets and/or project(s) where emission offsets might be available or appropriate, and assists, in some situations, in bringing a buyer and seller together to conduct a trade of an emission offset. Purchases of outstanding offset credits may be made via computer implemented trading means, e.g., over an electronic network 120 in a known manner through appropriate computer network interfaces using, for example, the Internet and TCP/IP communication protocols, or through a private network. The interface with registries 130, 131, . . . 13n may not be applicable to all offset trades, but may be applicable only to offsets traded under a mandatory or regulated scheme, or under a voluntary scheme with a pre-existing registry. This depiction of a “national registry” 130 may also represent such a pre-existing voluntary registry.

Trading platform 140 may be connected electronically to aggregator 110 via network 120. Trading platform 140 may include processor 141, memory device(s) 142 which may contain database 143, e.g., a structured database. Processor 141 may be part of a personal computer, computer workstation, or mainframe computer, and may also represent multi-processor configurations useful, with proper programming, to improve processing speed.

Memory device(s) 142 may be, for example, known types of solid-state memory such as dynamic random access memory (DRAM) that stores information, including information formatted for storage in structured database 143. Memory 142 may be backed up by known redundant storage media, e.g., tape backup (not shown). Structured database 143 may be implemented, for example, as a Structured Query Language (SQL) database or other type of known database format that is compatible or desired to be used with the particular software programming approach used to implement the trade platform. Structured database 143 may be configured to store information including, for example, information relating to multiple investors, multiple offset projects and associated offset units, e.g., CER, ERU, etc., multiple aggregators 110, the status of any previously traded and/or expired voluntary offset in a registry-type format, any national registry associated with a mandatory or regulated offset scheme, and the custodian of any related securitized offset.

User interface 144 may be implemented by any number of conventional input/output and/or display devices, e.g., mouse, keyboard, touch screen, etc. Peripherals 145 represent other conventional computer peripheral devices such as displays, printers, additional and/or mass storage devices, and scanner, for example.

Trading platform 140 may electronically interface with one or more securities exchanges 150, e.g., the New York Stock Exchange (NYSE), National Association of Securities Dealers Automated Quotations (NASDAQ), or the London Stock Exchange (LSE), via a private network/communications channel, or over network 120. Precautions necessary to ensure the privacy and security of electronic data exchanged between parties may be taken in any number of known ways.

Trading platform 140 may also electronically interface with Central Securities Depository (CSD) 160 via a private network/communications channel, or over network 120. CSD 160 may be any one of a number of international securities clearing houses, e.g., the DTC, Euro Clear, or Clearstream, responsible for clearing and settlement of millions of dollars of securities trades a day.

The Depository Trust & Clearing Corporation (DTCC), based primarily in New York City, is the world's largest post-trade financial services company. It was set up to provide an efficient and safe way for buyers and sellers of securities to make their exchange, and thus “clear and settle” transactions. It also provides custody of securities. User-owned and directed, it automates, centralizes, standardizes, and streamlines processes that are critical to the safety and soundness of the world's capital markets. Through its subsidiaries, DTCC provides clearance, settlement, and information services for equities, corporate and municipal bonds, unit investment trusts, government and mortgage-backed securities, money market instruments, and over-the-counter derivatives. DTCC is also a leading processor of mutual funds and insurance transactions, linking funds and carriers with their distribution networks. DTCC's DTC depository provides custody and asset servicing for 3.5 million securities issues, comprised mostly of stocks and bonds, from the United States and 110 other countries and territories, valued at $40 trillion, more than any other depository in the world. In 2007, DTCC settled the vast majority of securities transactions in the United States, more than $1.86 quadrillion in value. DTCC has operating facilities in New York City, and at multiple locations in and outside the U.S.

CSD 160 may interface with one or more custodians 170 which represent any number of custodial banks engaged in providing services related to securitized investor holdings, e.g., the Bank of New York Mellon.

Regulator 180 may be required under various national securities laws to approve any security offering made in its jurisdiction. For example, in the United States, the SEC is responsible for approving securities offered for public sale on registered stock exchange(s) 150. In the example of environmental offset credits that are “securitized” and offered for sale as a DR, e.g., a CCDR, SEC approval for such a security offering and registration is currently required. Similar regulatory approval is necessary in jurisdictions outside the U.S.

Processor 141 may also be configured to register, in structured database 143, an environmental offset to an owner, and to assign a unique identifier to the environmental offset assigned by regulator 180 to eliminate or at least make double-selling and double-accounting more difficult by specifically and uniquely identifying each offset credit so that there is no confusion as to the actual credit being sold, registered, or retired, and so that any attempted fraud would be more difficult to perpetrate. Such a unique identifier may be either a CUSIP or an ISIN identification number. The CUSIP identifier is a 9-character alphanumeric security identifier distributed by the Committee on Uniform Security Identification Procedures for all North American securities in order to facilitate the clearing and settlement of trades, discussed further below. The International Securities Identifying Number (ISIN) uses a 12-character alpha-numerical code having a structure defined in ISO 6166 that also serves for uniform identification of a security at trading and settlement.

In FIG. 1, the solid single ended arrow lines denote the flow for “issuance”, i.e., the securitization or equitization of environmental credits. The dashed single ended arrow denotes the flow for cancellation and retirement of environmental credits that have been “used”. the double ended long/short dashed arrows denote the flow of related data between various elements of trading system 100.

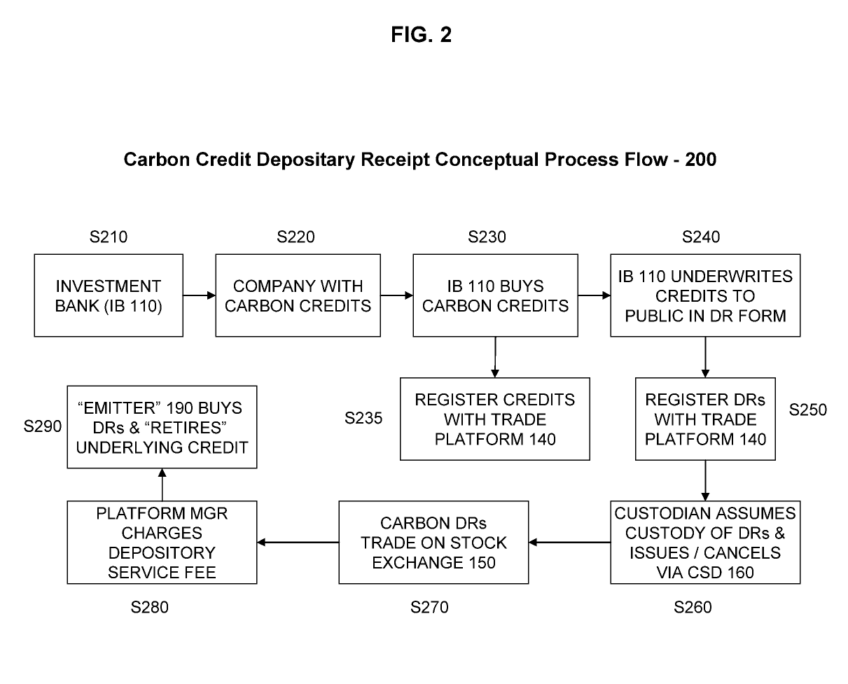

FIG. 2 depicts a conceptual process flow 200 associated with the creation, trading, and retirement/cancellation of carbon credits. These carbon credits are not limited to “pure” carbon credits, but may represent carbon credit equivalents (e.g., CO₂e) used to trade offset credits for greenhouse gases, for example.

At step S210, an investment bank or B/D evaluates available offset credits, e.g., carbon credits, and identifies a company willing to sell such credits at step S220. In step S230, the IB purchases the credits, and then registers the credits with trading platform 140, which can be, for example, the Global Environmental Markets (GEM) Registry operated by the Bank of New York Mellon.

At step S240, the IB underwrites the credits to the public as a depositary receipt (DR) and registers the resulting DRs with trading platform 140 at step S250. A regulatory compliance/approval process (not shown) may generally be required by regulator 180 prior to registration of the DRs at step S250. Once issued as one or more DRs, custodian 170 assumes custody of the securitized/equitized environmental credit, e.g., a CCDR, via CSD 160. Buyer/purchaser 190 of the CCDR, e.g., a pollution emitter, may buy the security on stock exchange 150 at step S270. The manager of trading platform 140 may charge a depository service fee (DSF) for services related to registration, custody, and/or trading of the CCDRs at step S280, and purchaser/emitter 190 may buy the CCDRs and “retire” the underlying credit (e.g., retire the credit with registry 130) at step S290. Alternatively, a purchaser may resell the CCDR (without retirement) to another purchaser.

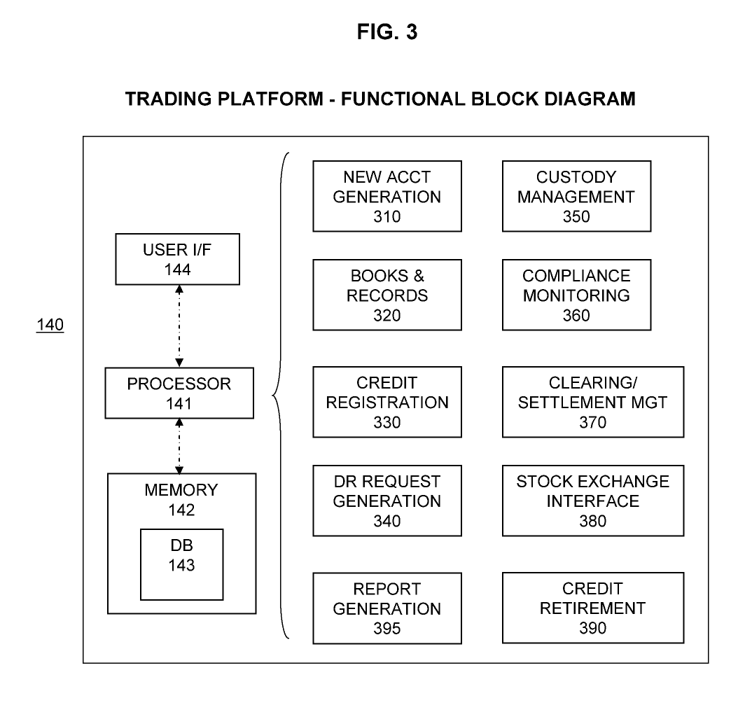

FIG. 3 illustrates various functional aspects of trading platform 140. The functional blocks/modules depicted in FIG. 3 may all be carried out by a properly programmed processor or processors, e.g., processor 141, using the novel and non-obvious DR securitization process of this disclosure.

New account generation block 310 provides the administrative support and functions necessary for establishing a trading account on platform 140, i.e., by registering the parties that are either purchasing or offering securities for sale, e.g., securitized carbon credits in the form of a CCDR.

Books and Records block 320 provides share owner services and functionality related to required and desired bookkeeping records, e.g., electronic book entry accounting, with an electronic communications path to CSD 160 for clearing and settling operations related to share owner transactions. Paper transactions are specifically disfavored in the embodiments of this disclosure.

Credit registration block 330 carries out the process necessary to register an existing offset credit, and would include processing to store information related to the owner, type of credit, and whether it is a voluntary or mandatory credit, and any related registry 130 (i.e., national or voluntary) with which the credit (or credits) is registered.

DR request generation block 340 carries out the actions necessary to “securitize” the underlying environmental credit, e.g., in the form of a DR or CCDR, with regulator 180, e.g., the SEC. Information required to be submitted to the SEC may be collected from database 143 and/or entered through user interface 144.

Custody management block 350 may either control and document securities under custodial control of the manager of platform 140, e.g., The Bank of New York Mellon, or may merely document the entity that is assigned custodial control of the securitized credit, e.g., JP Morgan.

Compliance monitoring block 360 carries out the functionality necessary to monitor and comply with reporting and documentation requirements imposed by governmental regulators, e.g., the SEC, under rule or law.

Clearing and settlement management block 370 provides information to CSD 160 that is used to manage the clearance and settlement of securities trades, e.g., when the CCDR is first offered for sale, and when the underlying credit is canceled or otherwise retired. CUSIP and/or ISIN identification of the DR credits involved reduces the chances for double counting of credits, or failing to retire a credit. Stock exchange interface 380 provides the necessary secure data interface for conducting electronic trades on stock exchange 150. Credit retirement block 390 carries out the functionality necessary to retire the underlying environmental credit with the registry involved in its original initiation/registration.

Report generation block 395 may generate client position statements relating to one or more of the equitized environmental offset credits. Such position statements may include information similar to that provided in known investment position statements, including, for example, the number and specific identification of each environmental offset credit, owner and/or seller information, and dates of purchase and/or sale of various offset credits, and the standard to which each credit was verified. The position statements may be provided by electronic form, e.g., via e-mail to the owner/client associated with the position, i.e., broker/dealers and/or investors (buyers/sellers). Reports may also be made via secure online (internet) access.

All of the above functional blocks may be provided with internal data interconnections with each other, and/or external communications access over network 120 to other elements of trading system 100 or through dedicated “private” networked connections. Although FIG. 3 distinguishes the above-identified functional entities, these aspects of embodiments discussed above may either be considered as being performed in separate functional blocks, or may be conceptually combined into one functional block, i.e., as a post-trade platform that provides accounting and reporting functions, or as a complete trade processing platform that executes trades as well as providing accounting and reporting functions.

Further, processor 141 may be configured to credit a client account in structured database 143 with a traded environmental offset. For example, offsetting credits and debits relating to traded environmental offsets may be entered into respective client accounts maintained in structured database 143.

In a further aspect, notification of the traded environmental offset may be provided to entities involved with the trade, for example, aggregator 110, purchaser 190, and custodian 170. The notification may be in an electronic form provided via network 120, for example, via e-mail which may include transaction details, or which may provide “online” access via a secure internet link, for example. In a further aspect, an electronic notification of a traded regulated environmental offset may be provided to a national registry 130 associated with the mandatory environmental offset via network 120, using a computer interface between processor 141 and registry 130.

In another aspect, trade platform 140 may also cause a clearing and netting operation to occur to consolidate and report trades between buyer-seller pairs during a predetermined time period, for example, at the close of a trading day. As used in banking and finance, “clearing” denotes all activities from the time a commitment is made for a transaction until it is settled. Clearing may be necessary because the speed of trades could be much faster than the cycle time for completing the underlying transaction. In general, “netting” means to allow a positive value and a negative value to set-off and partially or entirely cancel each other out. As an example in the context of this disclosure, netting means a process which enables parties to a trade to settle only the net positions with one another at the end of a period of time, e.g., at the end of the day, in a single transaction, and not trade by trade. With proper accounting, this can be useful in situations where multiple trades are conducted between/by two aggregators 110, and/or where large sums of money would otherwise be required to be transferred. Reports of the cleared/netted transactions may be provided by electronic form, e.g., via e-mail to parties associated with the trade, i.e., broker/dealers and/or investors (buyers/sellers). Reports may also be made via secure online (internet) access.

Furthermore, processor 141 may be configured to store information representing a physical offset certificate associated with a traded environmental offset into a book-entry form maintained in structured database 143.

Trade platform 140, by its handling of multiple buyers/sellers (investors) and broker/dealers, as well as equitized regulated and voluntary offsets under different standards/protocols, provides a strong position in the carbon markets, including emerging carbon markets in Canada, Australia, Japan, U.S. regional programs, and Carbon exchanges such as Chicago Climate Exchange (CCX), and creates opportunities for related opportunities in areas such as carbon fund administration, bridge and project financing, and as a service provider of consolidated carbon market data, since such consolidated market data does not exist. Services that may be provided to existing and future carbon funds by the trade platform and method of this disclosure include accounting, net asset value calculations, payments and cash management, as well as trade execution and project financing.

As discussed above, the environmental offset may be a carbon offset, e.g., a verified voluntary offset such as a CFI carbon credit issued by the Chicago Climate Exchange, or the environmental offset may be a verified and regulated carbon offset, e.g., a Certified Emission Reduction (CER) compliant with the Kyoto Clean Development Mechanism (CDM). The environmental offset may be verified using a verification standard compliant with the Kyoto Clean Development Mechanism (CDM) or compliant with other certified verification agents. In another aspect, the offset may be a non-carbon related offset, such as an acid rain offset managed by the U.S. Environmental Protection Agency (EPA). The use of verified environmental offsets helps ensure the validity and authenticity of the underlying allowance, which helps increase visibility and remove uncertainties associated with allowance validity from the trading and settlement of environmental credits.

Other voluntary carbon offset verification protocols or standards accommodated by trade platform 100 include, but are not limited to various known standards, e.g., the Gold Standard, the Voluntary Carbon Standard (VCS), the Green-e standard, CCB standards, Plan Vivo, Climate Neutral Network, Greenhouse Friendly, WBCSD/WRI Protocol, CCAR, VER+standard, ISO 14064, VOS, Social Carbon, and DEFRA standards.

In another aspect of various embodiments, in order to reduce the paper storage and physical transfer requirements, a physical offset certificate associated with the traded environmental offset may be converted into a book-entry form maintained in database 143, thus facilitating electronic data transfer representing the buying and selling of an offset over network 120. These offsets can be established under a regulated mandatory offset scheme or under a voluntary offset scheme.

In a further aspect, a record of current and historical offset positions for one or more clients and market prices may be stored in database 143, and such information may be retrieved and formatted into paper or electronic reports, including e-mail reports to a client or other entity. Online access may also be made available. Such data reporting may include client position statements relating to one or more of the plurality of environmental offsets established in the two or more different offset markets.

In another aspect, the environmental offset is not limited to carbon offsets of either the regulated or voluntary type, but the offset may be an acid rain offset, for example, managed by the U.S. Environmental Protection Agency.

In another aspect of an embodiment, CCDRs with identical characteristics could be pooled together further enhancing liquidity. CCDRs with different characteristics could be used to construct Carbon Credit Exchange Traded Funds (ETF) which would deepen liquidity. The issuance/cancellation of CCDRs is an excellent way to monitor and ensure proper retirement of credits, and would enhance current carbon registry platforms operated by, for example, the Corporate Trust division of The Bank of New York Mellon.

The above-discussed embodiments and aspects of this disclosure are not intended to be limiting, but have been shown and described for the purposes of illustrating the functional and structural principles of the inventive concept, and are intended to encompass various modifications that would be within the spirit and scope of the following claims.

What is claimed is:

1. A computer-implemented method of creating and trading securitized environmental offset credits in a registered securities exchange, the method comprising:
providing a processor, memory device, at least one user interface, and a network connection arranged in an online trading platform;
registering, in a database in the memory device and via the network connection, one or more environmental offset credits to respective owners thereof;
requesting, via the network, equitization of at least a portion of the one or more environmental offset credits by a securities regulator;
applying a unique identifier supplied by the securities regulator to the equitized one or more environmental offset credits; and
assigning custody of each of the equitized one or more environmental offset credits to a custodian and storing the custodian assignment in the database.

2. The method of claim 1, wherein the one or more environmental offset credits comprises a carbon offset credit.

3. The method of claim 2, wherein the one or more environmental offset credits comprises a voluntary carbon offset credit.

4. The method of claim 2, wherein the one or more environmental offset credits comprise a mandatory carbon offset credit required by a governmental entity.

5. The method of claim 1, wherein the one or more environmental offset credits comprises a carbon-equivalent offset credit.

6. The method of claim 1, further comprising trading the equitized one or more environmental offset credits on a regulated stock exchange.

7. The method of claim 6, further comprising, after the equitized one or more environmental offset credits has been traded on the regulated stock exchange, retiring all offset credits underlying the equitized one or more environmental offset credits.

8. The method of claim 7, wherein said any underlying offset credits are retired in an associated national registry.

9. The method of claim 1, wherein said equitizing at least a portion of the one or more environmental offset credits comprises creating a depositary receipt (DR) registered with a governmental regulatory agency.

10. The method of claim 9, wherein the governmental regulatory agency is the Securities Exchange Commission (SEC).

11. The method of claim 9, wherein said depositary receipt (DR) comprises a carbon credit DR (CCDR).

12. The method of claim 1, wherein the unique identifier comprises either a CUSIP or an ISIN identification number.

13. The method of claim 1, further comprising setting a Depositary Receipt (DR) ratio that enables a plurality of greenhouse gases to be traded as one security or as a basket of securities.

14. A networked system for computerized creation and trading of securitized environmental offset credits tradable in a registered securities exchange, the system comprising:
an online trading platform comprising a processor, a memory device, at least one user interface, and a network connection operatively coupled together;
a structured database arranged in the memory device and configured to store registration information received over the network connection and processed by said processor, said registration information being related to one or more environmental offset credits registered to respective owners thereof;
wherein the processor is configured:
responsive to a user input received over the user interface, to request equitization of at least a portion of the one or more environmental offset credits with a securities regulator via the network,
to receive, over the network from the securities regulator, one or more unique identifiers associated with the equitized one or more environmental offset credits,
to store the received one or more unique identifiers in the structured database, and
to designate, over the network, an associated custodian for each of the equitized one or more environmental offset credits and to store the associated custodians in the structured database for each of the equitized one or more environmental offset credits.

15. The system of claim 14, wherein the one or more environmental offset credits comprises a carbon offset credit.

16. The system of claim 15, wherein the one or more environmental offset credits comprises a voluntary carbon offset credit.

17. The system of claim 15, wherein the one or more environmental offset credits comprise a mandatory carbon offset credit required by a governmental entity.

18. The system of claim 14, wherein the one or more environmental offset credits comprises a carbon-equivalent offset credit.

19. The system of claim 14, further comprising trading the equitized one or more environmental offset credits on a regulated stock exchange.

20. The system of claim 19, further comprising, after the equitized one or more environmental offset credits has been traded on the regulated stock exchange, retiring all offset credits underlying the equitized one or more environmental offset credits.

21. The system of claim 20, wherein said any underlying offset credits are retired in an associated national registry.

22. The system of claim 14, wherein said equitizing at least a portion of the one or more environmental offset credits comprises creating a depositary receipt (DR) registered with a governmental regulatory agency.

23. The system of claim 22, wherein the governmental regulatory agency is the Securities Exchange Commission (SEC).

24. The system of claim 22, wherein said depositary receipt (DR) comprises a carbon credit DR (CCDR).

25. The system of claim 14, wherein the unique identifier comprises either a CUSIP or an ISIN identification number.

26. The system of claim 14, wherein the equitized one or more environmental offset credits comprise a single security or basket of securities established by setting a Depositary Receipt (DR) ratio that enables a plurality of greenhouse gases to be traded.

27. An article of manufacture comprising a tangible computer-readable medium therein, said computer-readable medium containing computer-readable instructions thereon which, when executed by a computer processor, cause the processor to carry out functions related to creating and trading securitized environmental offset credits in a registered securities exchange, the functions comprising:
registering, in a structured database in a memory device, one or more environmental offset credits to respective owners thereof;
requesting equitization of at least a portion of the one or more environmental offset credits by a securities regulator;
storing, for each equitized one or more environmental offset credits, a unique identifier supplied by the securities regulator in the structured database; and
assigning, to a custodian, custody of the equitized one or more environmental offset credits in the database.
